(19) United States
(12) Patent Application Publication
(10) Pub. No.: US 2024/0167889 A1
(43) Pub. Date: May 23, 2024

(54) MOSFET-Based Temperature Sensing

(71) Applicant: QUALCOMM Incorporated, San Diego, CA (US)

(72) Inventors: Balasubramanian SIVAKUMAR, San Diego, CA (US); Liang DAI, San Diego, CA (US); Dinesh Jagannath ALLADI, San Diego, CA (US)

(21) Appl. No.: 17/989,614

(22) Filed: Nov. 17, 2022

(51) Int. Cl. G01K 7/01

(52) U.S. Cl. CPC G01K 7/01

(57) ABSTRACT

A subthreshold-based MOSFET temperature sensor is provided for generating a subthreshold leakage current that is proportional to a difference between a gate-to-source voltage of a first transistor and a gate-to-source voltage of a second transistor. The subthreshold leakage current is mirrored to a detector for a temperature determination.

### TECHNICAL FIELD

This application relates to temperature sensors, and more particularly to subthreshold-based MOSFET temperature sensors.

### BACKGROUND

Temperature sensors have multiple applications in a system-on-a-chip (SoC) integrated circuit. For example, a processor temperature sensor monitors the central processing unit (CPU) temperature so that the CPU operation may be throttled to avoid exceeding the thermal threshold for the CPU. Similarly, dynamic voltage scaling for the CPU power supply voltage and clocking frequency may be controlled responsive to a processor temperature sensor. In addition, a temperature sensor may be integrated with precision analog circuitry within an integrated circuit so that temperature effects may be compensated.

However, prior art temperature sensors have a number of issues with regard to their implementation. For example, bipolar junction transistors have commonly been used to form a temperature sensor. But bipolar transistors in modern complementary metal-oxide semiconductor (CMOS) processing nodes are parasitic devices that are relatively large and have increased variability as compared to metal-oxide semiconductor field-effect transistor (MOSFET) devices. Subthreshold-based MOSFET temperature sensors have thus been developed to avoid the use of bipolar junction transistors.

### SUMMARY

In accordance with an aspect of the disclosure, a temperature sensor is provided that includes: a first diode-connected transistor having a source coupled to a voltage node; a first transistor having a gate coupled to a gate of the first diode-connected transistor; a first resistor coupled between a source of the first transistor and the voltage node, wherein the first transistor is configured to conduct a subthreshold current that is proportional to a gate-to-source voltage difference between the first diode-connected transistor and the first transistor; and a first current mirror configured to mirror the subthreshold current through the first diode-connected transistor.

In accordance with another aspect of the disclosure, a temperature sensor method is provided that includes: generating a subthreshold current that is proportional to a difference between a gate-to-source voltage of a first transistor and a gate-to-source voltage of a second transistor; conducting a mirrored version of the subthreshold current to a detector; and generating an output voltage in the detector that is proportional to the mirrored version of the subthreshold current.

In accordance with yet another aspect of the disclosure, a temperature sensor is provided that includes: a first diode-connected transistor having a source coupled to a voltage node; a first transistor having a gate coupled to a gate of the first diode-connected transistor; a first resistor coupled between a source of the first transistor and the voltage node, wherein the first transistor is configured to conduct a subthreshold current that is proportional to a gate-to-source voltage difference between the first diode-connected transistor and the first transistor; and means for mirroring the subthreshold current through the first diode-connected transistor.

These and other advantageous features may be better appreciated through the following detailed description.

### BRIEF DESCRIPTION OF THE DRAWINGS

FIG. 1 is a circuit diagram of a conventional subthreshold-based MOSFET temperature sensor.

FIG. 2 is a circuit diagram of an improved subthreshold-based MOSFET temperature sensor that generates a subthreshold current that is proportional to a difference between the gate-to-source voltages of a pair of PMOS transistors in accordance with an aspect of the disclosure.

FIG. 3 is a circuit diagram of an improved subthreshold-based MOSFET temperature sensor that generates a subthreshold current that is proportional to a difference between the gate-to-source voltages of a pair of NMOS transistors in accordance with an aspect of the disclosure.

FIG. 4 illustrates an integrated circuit die including a plurality of subthreshold-based MOSFET temperature sensors in accordance with an aspect of the disclosure.

FIG. 5 is a flowchart for a method of operation for a subthreshold-based MOSFET temperature sensor in accordance with an aspect of the disclosure.

FIG. 6 illustrates some example electronic systems including a subthreshold-based MOSFET temperature sensor in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

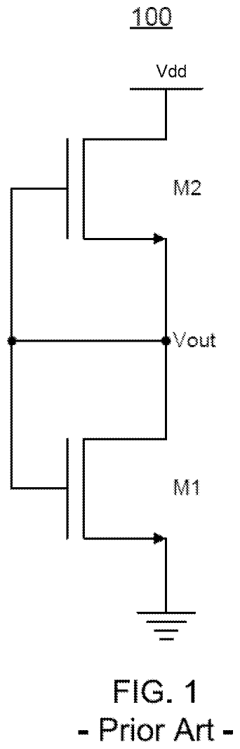

Some operation issues with regard to a subthreshold-based MOSFET temperature sensor may be better appreciated with reference to a traditional subthreshold-based MOSFET temperature sensor 100 shown in FIG. 1. An n-type metal-oxide semiconductor (NMOS) transistor M2 has its source connected to an output node for the output voltage Vout and has a drain connected to a power supply node for a power supply voltage Vdd. The gate of transistor M2 is also connected to the output node such that transistor M2 has a gate-to-source voltage of zero volts. Transistor M2 will thus conduct only a subthreshold leakage current. An NMOS diode-connected transistor M1 has its gate and drain connected to the output node and its source connected to ground. Diode-connected transistor M1 will thus conduct the subthreshold leakage current conducted by transistor M2. An impedance of diode-connected transistor M1 develops the output voltage Vout on the output node in response to the diode-connected transistor M1 conducting the subthreshold leakage current. Transistor M2 would typically be many times larger than diode-connected transistor M1 so that a sufficient amount of subthreshold leakage current is passed to produce the output voltage Vout at the drain of the diode-connected transistor M1.

It can be shown that the output voltage Vout of subthreshold-based MOSFET temperature sensor 100 has a proportional-to-absolute-temperature (PTAT) behavior. A detector circuit (not illustrated) can thus determine the temperature sensed by subthreshold-based MOSFET temperature sensor 100 by comparing the output voltage Vout to a temperature-independent reference voltage. Although subthreshold-based MOSFET temperature sensor 100 requires only two transistors, its operation still suffers from a number of problems. For example, the drain-to-source voltage (Vds) for transistor M2 is relatively large. Such a large Vds provokes additional leakage mechanisms such as gate-induced drain leakage (GIDL) effects that spoil the desired proportional-to-absolute temperature (PTAT) behavior of the subthreshold-based MOSFET temperature sensor 100.

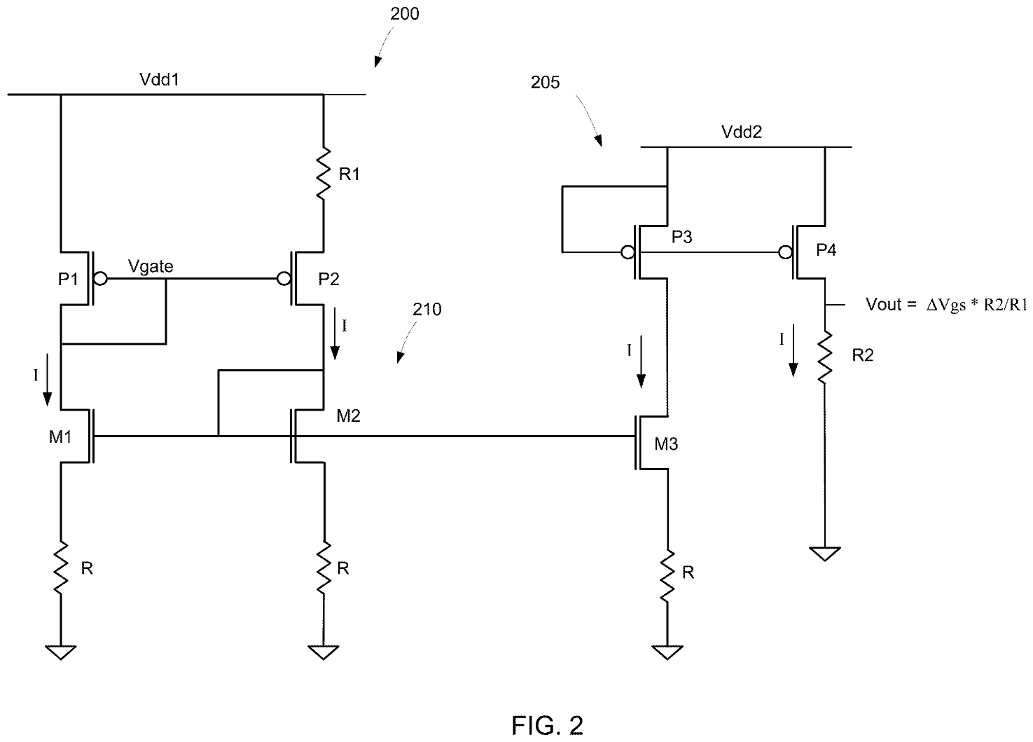

To provide stability with respect to process, temperature, and voltage (PVT) variations, a subthreshold-based MOSFET temperature sensor is provided that produces a current that is proportional to the gate-to-source voltage difference between a pair of transistors. The pair of transistors may both be NMOS transistors or instead may both be p-type metal-oxide-semiconductor (PMOS) transistors. A subthreshold-based MOSFET temperature sensor 200 that produces a current I that is proportional to the gate-to-source voltage difference between a pair of PMOS transistors P1 and P2 is shown in FIG. 2. Transistor P1 is diode-connected and thus has its drain coupled to its gate. A source of the diode-connected transistor P1 couples to a voltage node such as a power supply node for a first power supply voltage Vdd1. The gate of the diode-connected transistor P1 also couples to a gate of transistor P2. A source of transistor P2 couples to the power supply node through a resistor R1. As will be explained further herein, transistor P2 is biased so that transistor P2 conducts the current I. This current I will now be defined by the gate-to-source voltages of transistors P1 and P2 and also the resistance R1 as follows. Due to their gate-to-gate coupling, a gate voltage of the diode-connected transistor P1 is also the gate voltage of transistor P2. If this gate voltage is denoted as Vgate, then the gate-to-source voltage (Vgs1) of the diode-connected transistor P1 equals Vgate minus the power supply voltage Vdd1. A source voltage of transistor P2 equals the power supply voltage Vdd1 minus the ohmic voltage drop of PRI across resistor R1. The gate-to-source voltage (Vgs2) of transistor P2 thus equals Vgate−(Vdd1−I*R1). From these values of Vg1 and Vg2, it follows that a difference (ΔVgs) between Vgs2 and Vgs1 thus equals the product PRI such that the subthreshold current I conducted by transistor P2 equals ΔVgs/R1.

The drains of transistors P1 and P2 couple to a first current mirror 210 formed by an NMOS transistor M1 and a diode-connected transistor M2. The drain of the diode-connected transistor M2 couples to the drain of transistor P2, which forces the diode-connected transistor M2 to conduct the current I. A gate and the drain of diode-connected transistor M2 couple to a gate of transistor M1. A drain of transistor M1 couples to the drain of transistor P1. The sources of transistors M1 and M2 couple to ground through respective resistors of a pair of resistors R. This coupling through resistors R provides for better matching in subthreshold-based MOSFET temperature sensor 200 but it will be appreciated that the sources of transistors M1 and M2 may instead directly couple to ground in alternative implementations. Transistors M1 and M2 are matched (have the same width and length) such that transistor M1 conducts a mirrored version of the current I conducted by the diode-connected transistor M2. This forces the diode-connected transistor P1 to also conduct a mirrored version of the current I. Transistors P1 and P2 are both sized such that they operate in the subthreshold region when conducting the current I. The current I may thus also be denoted as a subthreshold current I. Transistor P2 may be larger than the diode-connected transistor P1. For example, in one implementation, transistor P2 may be four times larger than the diode-connected transistor P1 although other size ratios may be used with respect to the size difference between transistor P2 and the diode-connected transistor P1. Diode-connected transistor P1 is an example of a first diode-connected transistor as defined herein. Similarly, transistor P2 is an example of a first transistor as defined herein. In addition, the diode-connected transistor M2 is an example of a second diode-connected transistor as defined herein. Similarly, transistor M1 is an example of a second transistor as defined herein.

It can be shown that the gate-to-source voltages of transistors P1 and P2 have a complementary-to-absolute-temperature behavior that is subject to considerable PVT variability. In contrast, the ΔVgs difference between the gate-to-source voltages of transistors P1 and P2 has a PTAT temperature dependency that is relatively stable or robust to PVT variations. The subthreshold current I thus has a PTAT temperature dependency or profile that is advantageously stable with respect to PVT variations. A detector 205 may then receive a mirrored version of the subthreshold current I so as to conduct the mirrored version of the subthreshold current I across a resistor R2 to develop a detector output voltage Vout equaling a product I*R2 of the mirrored subthreshold current I and the resistance R2. The detector output voltage thus equals ΔVgs*R2/R1. The PTAT temperature dependency of the subthreshold current I may be measured at manufacture or simulated. Based upon this expected correlation between the subthreshold current I and the temperature of the subthreshold-based MOSFET temperature sensor 200, detector 205 may then determine the temperature being measured by the subthreshold-based MOSFET temperature sensor 200. For example, detector 205 could process the detector output voltage through a lookup table that correlates the detector output voltage to the temperature of the subthreshold-based MOSFET temperature sensor 200.

The output of the subthreshold-based MOSFET temperature sensor 200 to the detector 205 is the subthreshold current I. This is advantageous as compared to the voltage output of subthreshold-based MOSFET temperature sensor 100 as conducting the subthreshold current I across an integrated circuit is not subject to ground bounce as compared to transporting a voltage output. For detector 205 to receive the subthreshold current I, first current mirror 210 may include another NMOS transistor M3 having its gate coupled to the gate of the diode-connected transistor M2. Transistor M3 is an example of a third transistor as defined herein. A source of transistor M3 couples to ground through a resistor R as discussed for transistors M1 and M2. However, it will be appreciated that the source of transistor M3 may instead directly couple to ground in alternative implementations. With transistor M3 being matched to transistors M1 and M2, transistor M3 will also conduct a mirrored version of the subthreshold current I. First current mirror 210 is an example of a means for mirroring the subthreshold current through a first diode-connected transistor. Transistor M3 and a lead spanning from the drain of transistor M3 to is an example of a means for conducting a mirrored version of the subthreshold current from the temperature sensor to a detector that is also integrated into the integrated circuit die.

Detector 205 forms a second current mirror formed by a diode-connected PMOS transistor P3 and a PMOS transistor P4. A lead couples between a drain of transistor M3 o a drain of the diode-connected transistor P3. The gates of the diode-connected transistor P3 couples to the gate of transistor P4. To complete the second current mirror, transistor P4 is matched to the diode-connected transistor P3. The sources of transistors P3 and P4 couple to a power supply node for a second power supply voltage Vdd2 that may be equal to or may be different from the power supply voltage Vdd1. For example, subthreshold-based MOSFET temperature sensor 200 may be located in a first location of an integrated circuit die whereas detector 205 may be located in second location of the integrated circuit die that is remote from the first location (i.e., the second location being relatively displaced from the first location). In addition, subthreshold-based MOSFET temperature sensor 200 and detector 205 may be located in different power domains such that the second power supply voltage Vdd2 is distinct from the first power supply voltage Vdd1. Alternatively, detector 205 may be located in the same power domain as for subthreshold-based MOSFET temperature sensor 200 such that the second power supply voltage Vdd2 equals the first power supply voltage Vdd1. A drain of transistor P4 couples through resistor R2 to ground so that resistor R2 may conduct the mirrored version of the subthreshold current I as discussed earlier.

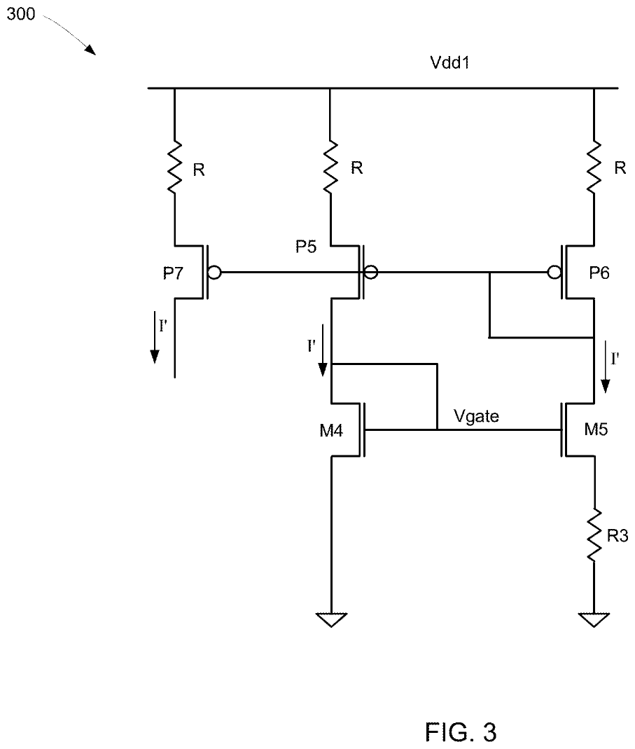

The pair of transistors that generate the gate-to-source difference voltage ΔVgs may instead be NMOS transistors. An example NMOS implementation 300 of a subthreshold-based MOSFET temperature sensor is shown in FIG. 3. An NMOS diode-connected transistor M4 has its source coupled to a voltage node such as ground and a gate coupled to a gate of a NMOS transistor M5. The source of transistor M5 couples to ground through a resistor R3. Transistor M5 conducts a current I′ through the resistor R3. A source voltage of transistor M5 is thus higher in voltage than ground by a product (I′*R3) of the current I′ and the resistance R3. A gate-to-source voltage (Vgs4) of transistor M4 equals a voltage Vgate of the gate of transistor M4. However, a gate-to-source voltage (Vgs5) of transistor M5 equals a difference between Vgate and the product I′*R3. A difference voltage ΔVgs between the gate-to-source voltage of transistor M5 and the gate-to-source voltage transistor M4 thus equals the product I′*R3. It follows that the current I′ equals ΔVgs/R3 analogously as discussed for subthreshold-based MOSFET temperature sensor 200. A first current mirror formed by a diode-connected PMOS transistor P6 having a gate coupled to a gate of a PMOS transistor P5 forces the diode-connected transistor M4 to also conduct a mirrored version of the current I′. A source of transistor P5 and a source of transistor P6 both couple to the power supply node for the first power supply voltage Vdd1 through respective resistors R. The use of resistors R increases the matching for subthreshold-based MOSFET temperature sensor 300 but it will be appreciated that the sources of transistors P6 and P6 may instead directly couple to the power supply node in alternative implementations.

The drain of transistor P6 couples to the drain of transistor M5 so that transistor M5 conducts the current I′. Transistors P5 and P6 are matched so that transistor P5 also conducts a mirrored version of the current I′. A drain of transistor P5 couples to a drain of transistor M4 so that transistor M4 conducts the mirrored version of the current I′ as well. Both transistor M4 and transistor M5 are sized so that they conduct the current I′ in the subthreshold region. Current I′ is thus a subthreshold current I′ as discussed analogously for subthreshold-based MOSFET temperature sensor 200. Transistor M5 is larger than the diode-connected transistor M4. For example, transistor M5 may be four times larger than the diode-connected transistor M4. It will be appreciated, however, that other size ratios between transistors M5 and M4 may be used in alternative implementations. To mirror the subthreshold current to a detector (not illustrated but analogous to detector 205), the first current mirror in subthreshold-based MOSFET temperature sensor 300 may include a PMOS transistor P7 that is matched to transistors P5 and P6. A gate of transistor P7 couples to the gates of transistors P5 and P6. A source of transistor P7 couples to the power supply node through a resistor R to match the use of resistors R with respect to transistors P5 and P6 but it will be appreciated that the source of transistor P7 may directly couple to the power supply node in alternative implementations. Transistor P7 will thus conduct a mirrored version of the subthreshold current I′ so that the mirrored version of the subthreshold current I′ may be distributed to the corresponding detector.

Diode-connected transistor M4 is an example of the first diode-connected transistor as defined herein. Similarly, transistor M5 is an example of the first transistor as defined herein. Diode-connected transistor P6 is an example of the second diode-connected transistor as defined herein. In addition, transistor P5 is an example of the second transistor as defined herein. Transistor P7 is an example of the third transistor as defined herein.

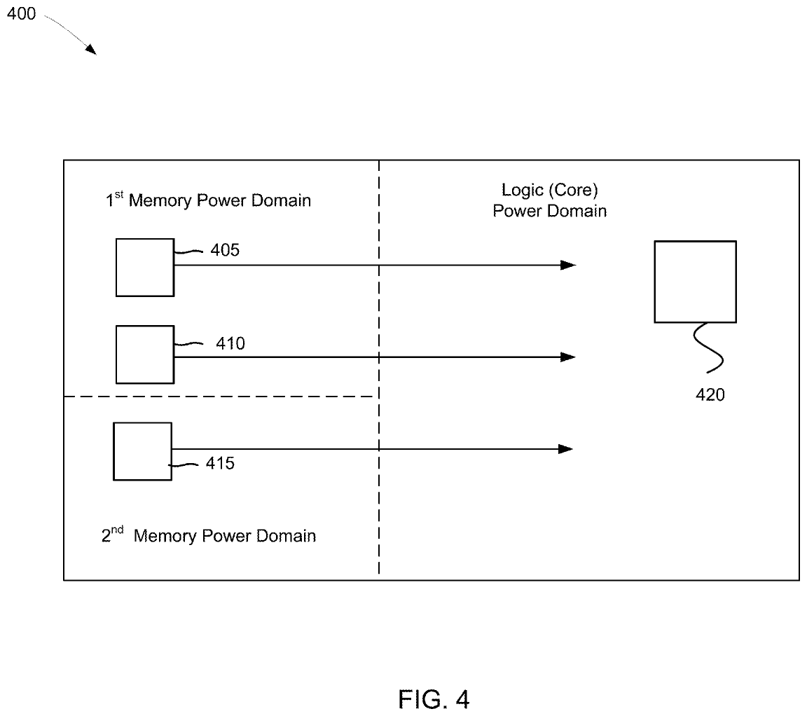

Regardless of whether an NMOS or a PMOS implementation is used, subthreshold-based temperature sensors as disclosed herein may be located at various locations and within various power domains in an integrated circuit die. An example integrated circuit die 400 is shown in FIG. 4. A first memory power domain includes a first subthreshold-based temperature sensor 405 and a second subthreshold-based temperature sensor 410. Similarly, a second memory power domain includes a third subthreshold-based temperature sensor 415. The mirrored subthreshold currents from these temperature sensors may be conducted across the integrated circuit die 400 to a detector 420 in a logic or core power domain.

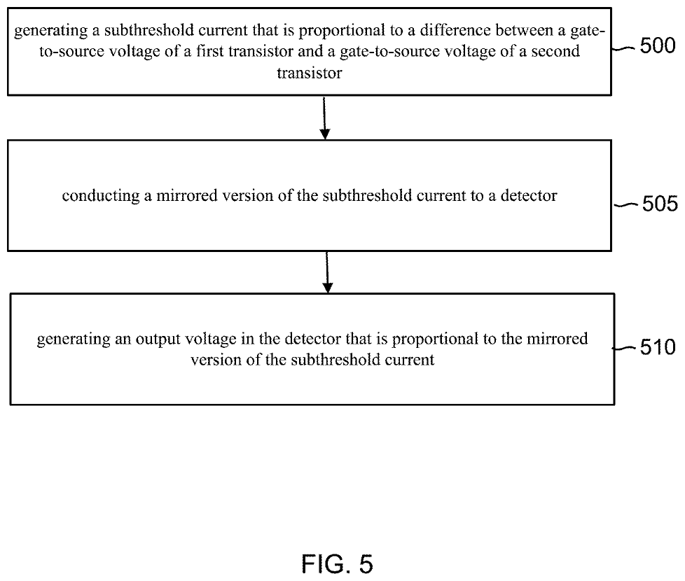

A method of operation for a subthreshold-based MOSFET temperature sensor will now be discussed with regard to the flowchart shown in FIG. 5. The method includes an act 500 of generating a subthreshold current that is proportional to a difference between a gate-to-source voltage of a first transistor and a gate-to-source voltage of a second transistor. The generation of the subthreshold current I in subthreshold-based MOSFET temperature sensor 200 or of the subthreshold current I′ in subthreshold-based MOSFET temperature sensor 200 is an example of act 500. In addition, the method includes an act 505 of conducting a mirrored version of the subthreshold current to a detector. The conduction of the subthreshold current I to detector 205 or the conduction of the subthreshold current I′ to a corresponding detector is an example of act 505. Finally, the method includes an act 510 of generating an output voltage in the detector that is proportional to the mirrored version of the subthreshold current. The generation of the detector output voltage in detector 205 is an example of act 510.

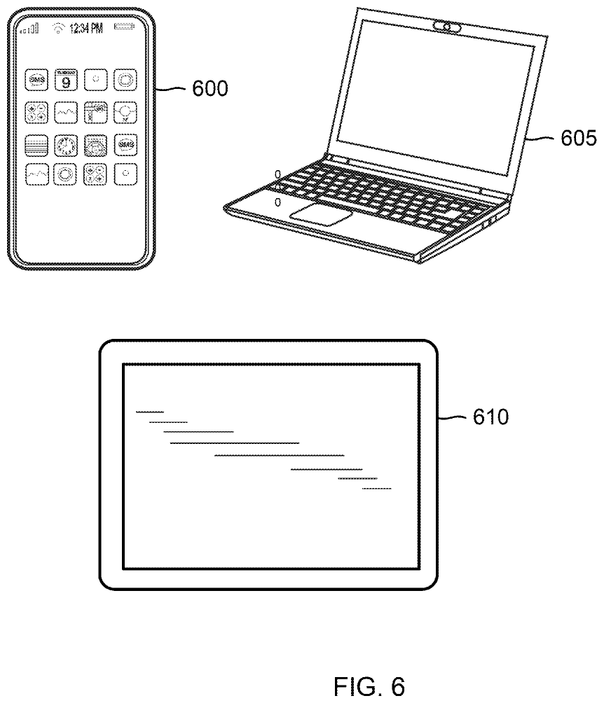

A subthreshold-based MOSFET temperature sensor as disclosed herein may be incorporated in any suitable mobile device or electronic system. For example, as shown in FIG. 6, a cellular telephone 600, a laptop computer 605, and a tablet PC 610 may all include a subthreshold-based MOSFET temperature sensor in accordance with the disclosure. Other exemplary electronic systems such as a music player, a video player, a communication device, and a personal computer may also be configured with a subthreshold-based MOSFET temperature sensor constructed in accordance with the disclosure.

The disclosure will now be summarized in the following series of clauses:

Clause 1. A temperature sensor, comprising:
a first diode-connected transistor having a source coupled to a voltage node;
a first transistor having a gate coupled to a gate of the first diode-connected transistor;
a first resistor coupled between a source of the first transistor and the voltage node, wherein the first transistor is configured to conduct a subthreshold current that is proportional to a gate-to-source voltage difference between the first diode-connected transistor and the first transistor; and a first current mirror configured to mirror the subthreshold current through the first diode-connected transistor.

Clause 2. The temperature sensor of clause 1, wherein the first current mirror comprises:
a second diode-connected transistor having a drain coupled to a drain of the first transistor;
a second transistor having a gate coupled to a gate of the second diode-connected transistor and having a drain coupled to a drain of the first diode-connected transistor.

Clause 3. The temperature sensor of clause 2, wherein the first current mirror further comprises:
a third transistor having a gate coupled to the gate of the second diode-connected transistor.

Clause 4. The temperature sensor of any of clauses 1-3, wherein the voltage node comprises a power supply node, and wherein the first diode-connected transistor and the first transistor each comprises a p-type metal-oxide-semiconductor (PMOS) transistor.

Clause 5. The temperature sensor of any of clauses 1-3, wherein the voltage node comprises ground, and wherein the first diode-connected transistor and the first transistor each comprises an n-type metal-oxide-semiconductor (NMOS) transistor.

Clause 6. The temperature sensor of clause 2, wherein the second diode-connected transistor and the second transistor each comprises an NMOS transistor, the temperature sensor further comprising:
a second resistor coupled between a source of the second transistor and ground; and
a third resistor coupled between a source of the second diode-connected transistor and ground.

Clause 7. The temperature sensor of clause 3, further comprising:
a detector coupled to a drain of the third transistor, the detector being configured to detect a mirrored version of the subthreshold current.

Clause 8. The temperature sensor of clause 7, wherein the first diode-connected transistor and the first transistor are integrated into a first location on an integrated circuit die, and wherein the detector is integrated into a second location on the integrated circuit die that is remote from the first location.

Clause 9. The temperature sensor of clause 8, wherein the first location is within a first power domain of the integrated circuit die, and wherein the second location is within a second power domain of the integrated circuit die.

Clause 10. The temperature sensor of clause 8, wherein the detector comprises a second current mirror configured to mirror the mirrored version of the subthreshold current through a second resistor to develop an output voltage that is proportional to an absolute temperature of the first location.

Clause 11. The temperature sensor of any of clauses 1-10, wherein the first transistor is larger than the first diode-connected transistor.

Clause 12. The temperature sensor of clause 11, wherein the first transistor is approximately four times larger than the first diode-connected transistor.

Clause 13. The temperature sensor of clause 9. wherein the first power domain is a memory power domain, and wherein the second power domain is a logic power domain.

Clause 14. The temperature sensor of clause 8, wherein the integrated circuit die is included within a cellular telephone.

Clause 15. A temperature sensor method, comprising:
generating a subthreshold current that is proportional to a difference between a gate-to-source voltage of a first transistor and a gate-to-source voltage of a second transistor;
conducting a mirrored version of the subthreshold current to a detector; and
generating an output voltage in the detector that is proportional to the mirrored version of the subthreshold current.

Clause 16. The temperature sensor method of clause 15, wherein the first transistor and the second transistor are located at a first location of an integrated circuit die and the detector is located at a second location of the integrated circuit die; and wherein conducting the mirrored version of the subthreshold current to the detector comprises conducting the mirrored version of the subthreshold current through a lead that spans from the first location of the integrated circuit die to the second location of the integrated circuit die.

Clause 17. The temperature sensor method of clause 16, further comprising:
determining a temperature dependence of the subthreshold current; and
processing the output voltage responsive to the temperature dependence to determine a temperature of the first location of the integrated die.

Clause 18. A temperature sensor, comprising:
a first diode-connected transistor having a source coupled to a voltage node;
a first transistor having a gate coupled to a gate of the first diode-connected transistor;
a first resistor coupled between a source of the first transistor and the voltage node, wherein the first transistor is configured to conduct a subthreshold current that is proportional to a gate-to-source voltage difference between the first diode-connected transistor and the first transistor; and
means for mirroring the subthreshold current through the diode-connected transistor.

Clause 19. The temperature sensor of clause 18, wherein the temperature sensor is integrated into an integrated circuit die, and wherein the means for mirroring the subthreshold current includes a means for conducting a mirrored version of the subthreshold current from the temperature sensor to a detector that is also integrated into the integrated circuit die.

Clause 20. The temperature sensor of clause 18, wherein the voltage node comprises a power supply node, and wherein the first diode-connected transistor and the first transistor each comprises a PMOS transistor.

Clause 21. The temperature sensor of clause 18, wherein the voltage node comprises ground, and wherein the first diode-connected transistor and the first transistor each comprises an NMOS transistor.

Clause 22. The temperature sensor of clause 18, wherein the first transistor is larger than the first diode-connected transistor.

It will be appreciated that many modifications, substitutions and variations can be made in and to the materials, apparatus, configurations and methods of use of the devices of the present disclosure without departing from the scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

We claim:

1. A temperature sensor, comprising:
a first diode-connected transistor having a source coupled to a voltage node;
a first transistor having a gate coupled to a gate of the first diode-connected transistor;
a first resistor coupled between a source of the first transistor and the voltage node, wherein the first transistor is configured to conduct a subthreshold current that is proportional to a gate-to-source voltage difference between the first diode-connected transistor and the first transistor; and
a first current mirror configured to mirror the subthreshold current through the first diode-connected transistor.

2. The temperature sensor of claim 1, wherein the first current mirror comprises:
a second diode-connected transistor having a drain coupled to a drain of the first transistor;
a second transistor having a gate coupled to a gate of the second diode-connected transistor and having a drain coupled to a drain of the first diode-connected transistor.

3. The temperature sensor of claim 2, wherein the first current mirror further comprises:
a third transistor having a gate coupled to the gate of the second diode-connected transistor.

4. The temperature sensor of claim 1, wherein the voltage node comprises a power supply node, and wherein the first diode-connected transistor and the first transistor each comprises a p-type metal-oxide-semiconductor (PMOS) transistor.

5. The temperature sensor of claim 1, wherein the voltage node comprises ground, and wherein the first diode-connected transistor and the first transistor each comprises an n-type metal-oxide-semiconductor (NMOS) transistor.

6. The temperature sensor of claim 2, wherein the second diode-connected transistor and the second transistor each comprises an NMOS transistor, the temperature sensor further comprising:
a second resistor coupled between a source of the second transistor and ground; and
a third resistor coupled between a source of the second diode-connected transistor and ground.

7. The temperature sensor of claim 3, further comprising:
a detector coupled to a drain of the third transistor, the detector being configured to detect a mirrored version of the subthreshold current.

8. The temperature sensor of claim 7, wherein the first diode-connected transistor and the first transistor are integrated into a first location on an integrated circuit die, and wherein the detector is integrated into a second location on the integrated circuit die that is remote from the first location.

9. The temperature sensor of claim 8, wherein the first location is within a first power domain of the integrated circuit die, and wherein the second location is within a second power domain of the integrated circuit die.

10. The temperature sensor of claim 8, wherein the detector comprises a second current mirror configured to mirror the mirrored version of the subthreshold current through a second resistor to develop an output voltage that is proportional to an absolute temperature of the first location.

11. The temperature sensor of claim 1, wherein the first transistor is larger than the first diode-connected transistor.

12. The temperature sensor of claim 11, wherein the first transistor is approximately four times larger than the first diode-connected transistor.

13. The temperature sensor of claim 9, wherein the first power domain is a memory power domain, and wherein the second power domain is a logic power domain.

14. The temperature sensor of claim 8, wherein the integrated circuit die is included within a cellular telephone.

15. A temperature sensor method, comprising:
generating a subthreshold current that is proportional to a difference between a gate-to-source voltage of a first transistor and a gate-to-source voltage of a second transistor;
conducting a mirrored version of the subthreshold current to a detector; and
generating an output voltage in the detector that is proportional to the mirrored version of the subthreshold current.

16. The temperature sensor method of claim 15, wherein the first transistor and the second transistor are located at a first location of an integrated circuit die and the detector is located at a second location of the integrated circuit die; and wherein conducting the mirrored version of the subthreshold current to the detector comprises conducting the mirrored version of the subthreshold current through a lead that spans from the first location of the integrated circuit die to the second location of the integrated circuit die.

17. The temperature sensor method of claim 16, further comprising:
determining a temperature dependence of the subthreshold current; and
processing the output voltage responsive to the temperature dependence to determine a temperature of the first location of the integrated die.

18. A temperature sensor, comprising:
a first diode-connected transistor having a source coupled to a voltage node;
a first transistor having a gate coupled to a gate of the first diode-connected transistor;
a first resistor coupled between a source of the first transistor and the voltage node, wherein the first transistor is configured to conduct a subthreshold current that is proportional to a gate-to-source voltage difference between the first diode-connected transistor and the first transistor; and
means for mirroring the subthreshold current through the first diode-connected transistor.

19. The temperature sensor of claim 18, wherein the temperature sensor is integrated into an integrated circuit die, and wherein the means for mirroring the subthreshold current includes a means for conducting a mirrored version of the subthreshold current from the temperature sensor to a detector that is also integrated into the integrated circuit die.

20. The temperature sensor of claim 18, wherein the voltage node comprises a power supply node, and wherein the first diode-connected transistor and the first transistor each comprises a PMOS transistor.

21. The temperature sensor of claim 18, wherein the voltage node comprises ground, and wherein the first diode-connected transistor and the first transistor each comprises an NMOS transistor.

22. The temperature sensor of claim, 18, wherein the first transistor is larger than the first diode-connected transistor.
